(19) United States
(12) Patent Application Publication
(10) Pub. No.: US 2008/0272860 A1
(43) Pub. Date: Nov. 6, 2008

(54) Tunable Dielectric Resonator Circuit

(75) Inventor: Kristi Dhimiter Pance, Auburndale, MA (US)

Correspondence Address: TYCO TECHNOLOGY RESOURCES, 4550 NEW LINDEN HILL ROAD, SUITE 140, WILMINGTON, DE, 19808-2952, US

(73) Assignee: M/A-Com, Inc., Lowell, MA (US)

(21) Appl. No.: 11/742,671

(22) Filed: May 1, 2007

(51) Int. Cl. H01P 7/10; H01P 1/20

(52) U.S. Cl. 333/219.1; 333/235

(57) ABSTRACT

A dielectric resonator circuit is provided that is tunable over a broad frequency range and/or a broad bandwidth range. The center frequency is made tunable over a broad range by use of a dielectric tuning plug that is positioned in a through hole within the resonator. The bandwidth is made tunable over a broad range by tilting the resonators relative to the enclosure to increase the effective height of the cavity as seen by the resonator.

### BACKGROUND

1. Field of the Invention

The invention pertains to dielectric resonator circuits. More particularly, the invention pertains to dielectric resonator filters that are tunable over a broad bandwidth range and a broad frequency range.

2. Background of the Invention

WiMAX (Worldwide Inter-Operability For Microwave Access) is a wireless industry coalition organized to advance IEEE 802.16 standards for broadband wireless access networks. WiMAX 802.16 technology is adapted to enable multimedia applications with a wireless connection. WiMAX 802.16 has a range of up to 30 miles, presenting network providers with a wireless, last-mile solution for wideband data transmission.

According to the WiMAX IEEE 802.16 specification, WiMAX transmitters transmit data at frequencies between 2500 MHz and 2700 MHz or between 3500 MHz and 3700 MHz and may have channel bandwidths between 5 MHz and 30 MHz.

Accordingly, there is a need to supply the WiMAX 802.16 industry with microwave filters that can provide band pass filters capable of offering these parameters.

To minimize manufacturing and design costs, it would be beneficial for the manufacturers of filters for the WiMAX industry to be able to manufacture a filter of a single basic design that can be easily and inexpensively tuned to provide a passband over these broad frequency and bandwidth ranges.

Dielectric resonator circuits and filters are commonly used in the wireless microwave transmission field because of their very high quality factor, Q, and thus low losses.

FIG. 10 is a perspective view of a typical dielectric resonator of the prior art and FIG. 11 is a perspective view of a typical dielectric resonator filter circuit 20 of the prior art. As can be seen in FIG. 10, the resonators 10 are formed as cylinders 12 of dielectric material with a circular, longitudinal through hole 14. With reference to FIG. 11, the resonators 10a, 10b, 10c, 10d are arranged in the cavity 22 of a conductive enclosure 24. The conductive enclosure 24 typically is rectangular. The enclosure 24 commonly is formed of aluminum and may be silver-plated, but other materials also are well known. The resonators 10a, 10b, 20c, 10d may be attached to the floor of the enclosure, such as by an adhesive, but also may be suspended above the floor of the enclosure by a low-loss dielectric post.

Dielectric resonators have multiple modes of electrical fields and magnetic fields concentrated at different center frequencies. A mode is a field configuration corresponding to a resonant frequency of the system as determined by Maxwell's equations. In a dielectric resonator, the fundamental resonant mode frequency, i.e., the lowest frequency, is normally the transverse electric field mode, TE₀₁ (or TE hereinafter). Typically, the fundamental TE mode is the desired mode of the circuit or system in which the resonator is incorporated.

Microwave energy is introduced into the cavity by an input coupler 28. That energy electromagnetically couples from the input coupler to the first dielectric resonator. Conductive separating walls 32a-32d separate the resonators from each other and block (partially or wholly) coupling between physically adjacent resonators 10. Particularly, irises 30a, 30b, 30c in walls 32b, 32c, 32d control the coupling between adjacent resonators 10a-10b, 10b-10c, and 10c-10d. Walls without irises generally prevent any coupling between adjacent resonators separated by those walls. Walls with irises allow some coupling between adjacent resonators separated by those walls. By way of example, the dielectric resonators 10a, 10b, 10c, 10d in FIG. 2 electromagnetically couple to each other sequentially, i.e., the energy from input coupler 28 couples into resonator 10a, resonator 10a couples with resonator 10b through iris 30a, resonator 10b couples with resonator 10c through iris 30b, resonator 10c couples with resonator 10d through iris 30c. An output coupler 40 is positioned adjacent the last resonator 10d to couple the microwave energy out of the filter 20. Wall 32a, which does not have an iris, prevents the field of resonator 10a from coupling with physically adjacent resonator 10d on the other side of the wall 32a. Likewise, by way of example, walls 32b, 32c, and 32d block resonator 10b from coupling with resonator 10d and block resonator 10a from coupling with resonator 10c.

Generally, both the bandwidth and the center frequency of the filter must be set very precisely. Bandwidth is essentially dictated by the coupling between the dielectric resonators and, therefore, is affected by (a) the spacing between the individual dielectric resonators 10 of the circuit and (b) the metal between the dielectric resonators (i.e., the size and shape of the housing 24, the walls 32 and the irises 30 in those walls, as well as any tuning screws placed between the dielectric resonators as discussed below). Frequency, on the other hand, is primarily a function the size of the individual dielectric resonators and the metal adjacent the individual resonators.

Initial frequency and bandwidth tuning of these circuits is done by selecting a particular size and shape for the housing and the spacing between the individual resonators. Generally, a different housing design is developed and manufactured for every circuit having a different frequency and/or bandwidth. Once the housing and initial design of the circuit is established, it is sometimes desirable to provide the capability to perform fine tuning of the frequency and/or bandwidth.

In order to permit such fine tuning of the frequency of such circuits after the basic design is developed, one or more metal tuning plates 42 may be attached to a top cover plate coaxially with a corresponding resonator 10 to affect the field of the resonator (and particularly the parasitic capacitance experienced by the resonator) in order to help set the center frequency of the filter. Particularly, plate 42 may be mounted on screws 43 passing through a threaded hole in the top cover plate (not shown) of enclosure 24. The screw may be rotated to vary the distance between the plate 42 and the resonator 10 to adjust the center frequency of the resonator.

Mechanisms also often are provided to fine tune the bandwidth of a dielectric resonator circuit after the basic design has been selected. For instance, conductive tuning screws 33 may be positioned in the irises 30 between the adjacent resonators to affect the coupling between the resonators. The tuning screws 33 can be rotated within threaded holes in the housing to increase or decrease the amount of conductor (e.g., metal) in the space between adjacent resonators in order to affect the capacitance between the two adjacent resonators and, therefore, the coupling therebetween. However, such tuning screws do not permit significant changes in coupling strength between the dielectric resonators. Tuning screws typically provide tunability of not much more than 15 percent.

Thus, for a standard dielectric resonator filter, tunability over a 200 MHz frequency range and over a bandwidth range from 5 MHz to 30 MHz for a single basic circuit design is not reasonably possible.

Furthermore, the Q of dielectric resonator circuits is highly sensitive to tuning, particularly at very high frequencies such as that required for WiMAX. The Q of a circuit is a measure of the ability of the circuit to concentrate the electromagnetic (EM) field energy without loss. More specifically the quality factor, Q, is proportional to the amount of stored EM energy divided by the amount of lost energy. Q is defined at resonance.

Accordingly, it is an object of the present invention to provide a dielectric resonator circuit that is tunable over a broad range of frequency and/or bandwidth, preferably, without substantially diminishing the Q of the circuit.

### SUMMARY OF THE INVENTION

In accordance with a first aspect of the invention, a dielectric resonator is provided comprising a first body component comprising a substantial portion of a generally annular shape and having an open space substantially interrupting the annular shape and a second body portion shaped to substantially fill the open space without contacting the first body portion.

In accordance with a second aspect of the invention, a dielectric resonator circuit is provided comprising an enclosure, an input coupler, an output coupler and at least one dielectric resonator disposed in the enclosure, each resonator comprising a first body component comprising first and second substantially parallel faces, the first and second faces joined by at least one third face running between the first and second faces defining a periphery of the body, a first through opening in the body extending in a first direction perpendicular to the first and second faces, the first opening defining a fourth, inner face of the body, and a second opening in a second direction perpendicular to the first direction extending from the at least one third face to the fourth face, and a second body component comprising a plug shaped and positioned to fit at least partially within the second opening, the second body component adjustably mounted to the enclosure so as to be movable relative to the first body component in the second direction to permit tuning of the circuit.

In accordance with a third aspect of the invention, a method is provided for tuning a dielectric resonator circuit comprising a plurality of dielectric resonators disposed in a housing, each resonator comprising a first body component comprising first and second substantially parallel faces, the first and second faces joined by at least one third face running between the first and second faces defining a periphery of the body, a first through opening in the body extending in a first direction perpendicular to the first and second faces, the first opening defining a fourth, inner face of the body, and a second opening in a second direction perpendicular to the first direction extending from the at least one third face to the fourth face and a second body component comprising a plug matingly shaped to and collinear with the second opening, the second body component adjustably mounted to the enclosure so as to be movable relative to the first body component in the second direction to permit tuning of the circuit, the method comprising adjustably mounting the second body components to the housing so that the second body components are movable in the second hole in the second direction relative to the first body component of the resonator and moving the second body components in the second direction to alter the center frequencies of the resonators.

### BRIEF DESCRIPTION OF THE DRAWINGS

FIG. 1 is a perspective view of a dielectric resonator in accordance with one embodiment of the present invention.

FIG. 2A is an elevational cross-sectional side view of the dielectric resonator of FIG. 1 with the tuning plug in a first position.

FIG. 2B is an elevational cross-sectional side view of the dielectric resonator of FIG. 1 with the tuning plug in a second position.

FIG. 3 is a perspective view of a dielectric resonator in accordance with another embodiment of the present invention.

FIG. 4A is a cross-sectional side view of the dielectric resonator of FIG. 1 showing the TE field concentration.

FIG. 4B is a cross-sectional side view of the dielectric resonator of FIG. 1 showing the magnetic field concentration.

FIG. 5 is a top plan view of an exemplary two pole dielectric resonator filter circuit illustrating a tilting feature in accordance with the principles of the present invention.

FIG. 6 is a graph of coupling strength in MHz as a function of tilting angle for the exemplary circuit of FIG. 5.

FIG. 7 is a perspective view of a dielectric resonator in accordance with another embodiment of the present invention.

FIG. 8A is an elevational cross-sectional side view of the dielectric resonator of FIG. 7 with the tuning plug in a first position.

FIG. 8B is an elevational cross-sectional side view of the dielectric resonator of FIG. 7 with the tuning plug in a second position.

FIG. 9 is a top plan view of an exemplary six pole dielectric resonator filter in accordance with the principles of the present invention.

FIG. 10 is a diagram of an exemplary dielectric resonator of the prior art.

FIG. 11 is a diagram of an exemplary dielectric resonator filter circuit of the prior art.

### DETAILED DESCRIPTION OF THE INVENTION

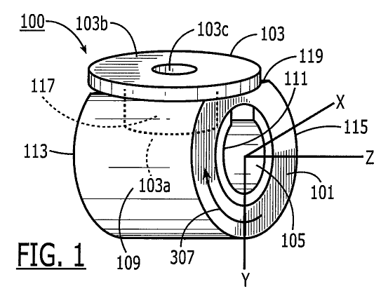

FIG. 1 is a perspective view illustrating a dielectric resonator 100 that is highly tunable, particularly in resonance (or center) frequency. The resonator comprises two body components 101 and 103. The first, main body component 101 is generally annular in shape with a through hole 105 in the longitudinal (z) dimension. The longitudinal dimension (z axis) is the direction perpendicular to the transverse electric (TE) mode direction (see arrow 307) and generally parallel to the lines of the magnetic field in the resonator at the geometric center of the resonator (i.e., on the z axis in the Figures). The first body component 101 of this resonator is somewhat similar in shape to a conventional cylindrical dielectric resonator with a longitudinal through hole. It has an outer annular surface 109, an inner annular surface at 111 and sidewalls 113, 115 connecting the outer and inner annular surfaces 109, 111. However, in addition, there is a second through hole 117 extending between the outer annular surface 109 and the inner annular surface 111. This hole is sized and shaped to accept the second body component 103 therethrough.

In a preferred embodiment, the second hole 117 is cylindrical.

The second body component 103 (herein termed the tuning plug body component) comprises a first portion 103a that is matingly sized and shaped to fit within the second through hole 117 so that it may pass through the second through hole and substantially fill the cross-section of the through hole, but is slightly smaller than the through hole 117 so that there will be no physical contact between the two body components 101, 103. In a preferred embodiment of the invention, the tuning plug 103 may further include a second portion 103b comprising a head that is larger in cross-section (in the x, z plane) than the first segment 103a. A through hole 103c is provided to accept a mounting post (not shown).

The tuning plug 103 and the main body portion 101 need not necessarily be made of the same dielectric material.

Moving the tuning plug 103 in the direction of the y axis changes the amount of dielectric material in the second through hole 117 of the main body component 101 and, therefore, alters the resonance frequency of the resonator 100. Accordingly, moving the tuning plug 103 along the y-axis tunes the resonance (or center) frequency of the resonator. Also, moving the tuning plug changes the gap between the head portion 103b of the tuning plug 103 and the adjacent surface 119 of the resonator, thereby modifying the tangential fields at the dielectric/air interfaces and decreasing the sensitivity of tuning.

In a dielectric resonator, electric fields are concentrated in the dielectric material due to the high dielectric constant of the dielectric resonator material. The magnetic field, however, is not concentrated because dielectric materials generally have a magnetic constant (or μ) of 1.

As previously noted, the resonance frequency of a resonator is primarily a function of the size and shape of the resonator, i.e., the amount of dielectric material within which the TE field mode is concentrated. Accordingly, moving the tuning plug changes the effective shape of the dielectric resonator as well as the amount of the dielectric material in the path of the TE mode field lines.

Particularly, the tuning plugs may be mounted on threaded screws passing through matingly threaded holes in the walls of the enclosure so that rotation of the screws causes the tuning plug to move linearly in the y direction. If the tuning plug is cylindrical or otherwise symmetric about its central axis in the y direction, the tuning plug can be rigidly mounted to the end of the screw (so that it rotates with the screw). If, however, the tuning plug is not symmetric about a central axis in the y direction, it may need to be mounted to the housing by means of a mounting mechanism in which the tuning plug does not rotate during linear movement in the y direction so that it does not hit the main body component 101. This could be accomplished by mounting the tuning plug on an unthreaded post frictionally engaged in a hole in the housing, for instance.

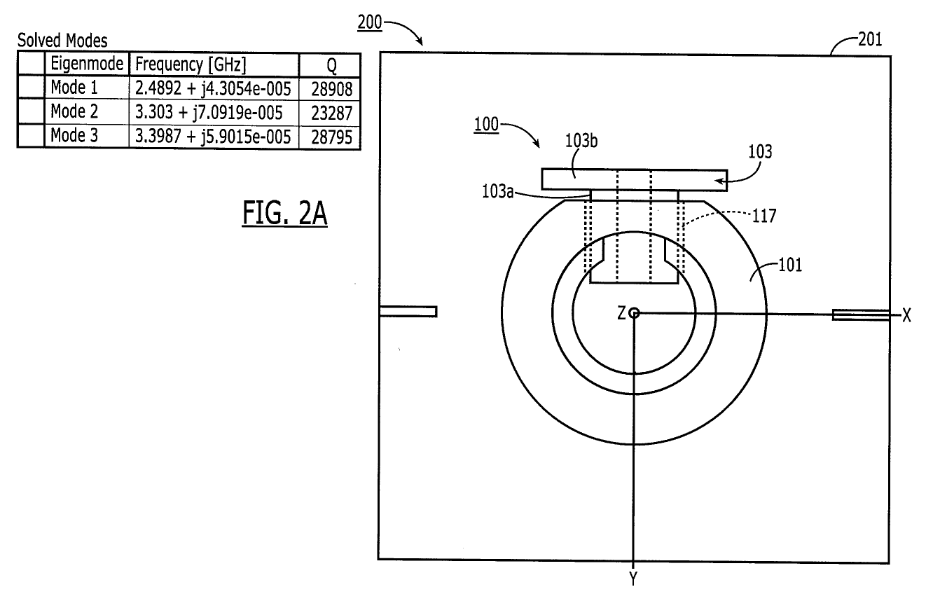

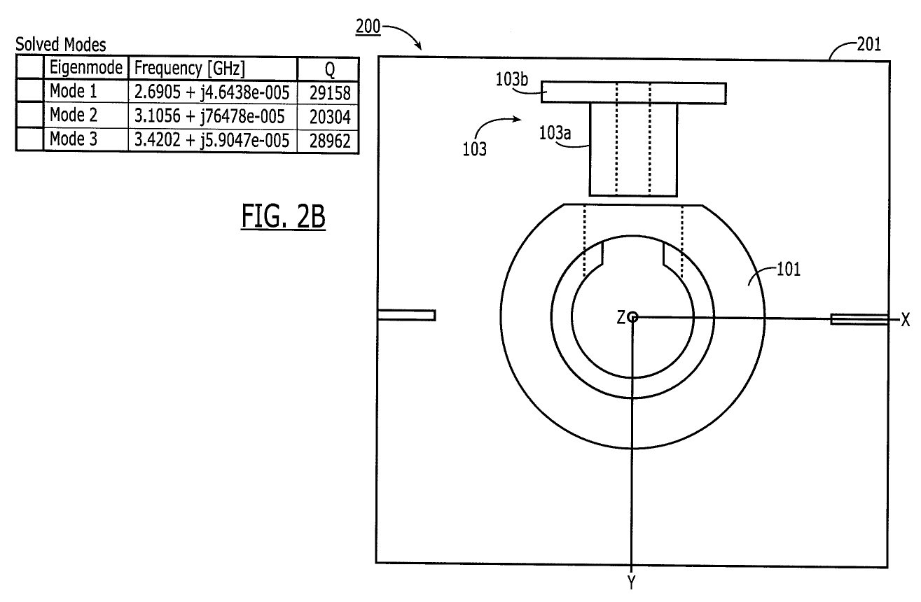

The portion 119 of the outer annular surface 109 of the main body portion 101 around the second through hole 117 may be made flat (as best seen in FIGS. 2A and 2B). This flat portion 119 is larger than the cross-section of the through hole 117 in both the x and the z directions.

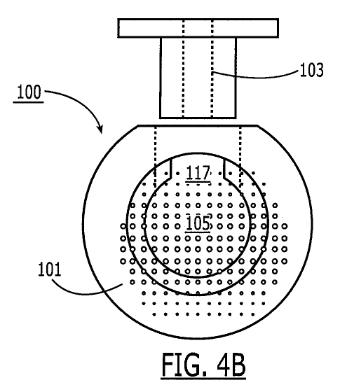

This flat portion 119 on the main body component 101 and/or the head portion 103b on the tuning plug body component 103 may be incorporated into the resonator, if desired, for the purpose of decreasing tuning sensitivity. These features may be omitted if it is desired to maximize tuning sensitivity. Particularly, FIG. 4A is a field strength diagram illustrating field distribution of the TE mode for the resonator of FIG. 1. As can be seen, much of the TE field is concentrated in the gaps 131 between the first and second body portions 101, 103. More particularly, the second through hole 117, which is oriented essentially transverse to the TE field lines, constitutes an interruption in the dielectric material that the TE field lines are concentrated within. This creates normal fields. The existence of normal fields increases tuning sensitivity. When the tuning plug 103 is positioned within the second through hole 117, it helps reduce the gap in dielectric material through which the TE field lines travel, thereby reducing the normal fields. The flat portion 117 of the first body component 101 and/or the enlarged head 103b on the tuning plug 103 introduce other irregularities in the shape of the dielectric material, thereby increasing the tangential fields, which decreases tuning sensitivity. Generally, the greater the magnitude of the tangential fields near the tuning plug 103, the lesser the change in center frequency as a result of the movement of the tuning plug relative the main body portion.

FIG. 2A is an elevational cross-sectional side view of a single pole dielectric resonator circuit 200 incorporating the resonator 100 of FIG. 1 with the tuning plug 103 positioned in a first position in which it is essentially fully inserted in and through the second through hole 117. The input and output couplers are not shown for simplicity. The enclosure 201 is 50 mm (x)×50 mm (y)×40 mm (z). The resonator has a diameter of 26 mm and a height in the Z dimension of 12 mm. The longitudinal through hole 105 has a diameter of 12 mm and the second through hole 117 has a diameter of 10 mm. The flattened portion 119 of the main body component is 14 mm long (in the Y dimension). The lower portion 103a of the tuning plug has a diameter of 9 mm and is 9 mm long, which is slightly smaller than the diameter of the second through hole 117. The head 103b of the tuning plug has a diameter of 18 mm and is 2 mm long. The tuning plug 103 is positioned centered in the second through hole 117.

Simulations show that, with the tuning plug 103 in this position, the center frequency of the fundamental TE mode is 2.4892 GHz and the circuit has a Q of 28,908. It has a spurious response of 800 MHz (i.e., the frequency of the next closest field mode is 800 MHz higher than the center frequency of the fundamental TE mode. FIG. 2B illustrates the same circuit with the tuning plug 103 moved up 9 mm so that it is completely out of the second through hole 117. In this position, the center frequency of the fundamental TE mode is 2.6905 GHz and the circuit has a Q of 29,158. Spurious response is 400 MHz.

Thus, it can be seen that a 9 mm movement of the tuning plug results in an approximately 200 MHz shift in center frequency (the full range required to cover the entire WiMAX range of either 2500 MHz-2700 MHz band or 3500-3700 MHz. Further, spurious response and Q are excellent and Q is almost unaffected over this tuning range.

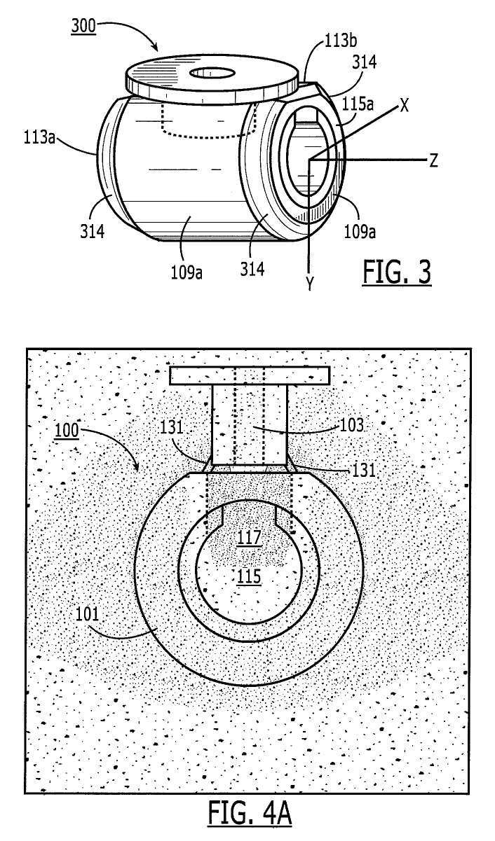

FIG. 3 is a perspective view illustrating a slightly different embodiment of a dielectric resonator 300 in accordance with the principles of the present invention. In this embodiment, the two side surfaces 113a, 115a of the main body portion have been trimmed near the outer annular wall 109a such that the side surfaces are beveled 314 adjacent the outer annular wall 109a. This beveling decreases the amount of dielectric material near the outer edges of the resonator body, resulting in at least two beneficial effects. First, it improves the spurious response, i.e., it causes the next lowest order mode to be further away from the fundamental mode. Furthermore, it increases coupling between adjacent resonators because more of the fundamental mode field is outside of the resonator body and exposed to the adjacent resonators. Therefore, bandwidth is increased.

The movement of the tuning plug 103 has little or no effect on the bandwidth of a dielectric resonator filter. Particularly, as previously noted, the dielectric materials generally have a magnetic constant of 1. Therefore, the magnetic field is not more concentrated in the resonator bodies than in the surrounding air. Hence, movement of the tuning plug will not substantially affect the magnetic field and therefore will not substantially affect the bandwidth of the filter.

Even further minimizing the affect of movement of the tuning plug on the magnetic field (and thus on coupling), is the fact that the electric field and the magnetic field are more physically separated in the resonators of the present invention as compared to conventional resonators. Specifically, FIG. 4B is a field strength diagram showing the magnetic field strength for the resonator of FIG. 1 with the tuning plug fully withdrawn, as shown in FIG. 2B. As can be seen, the magnetic field strength, which would be most concentrated in the middle of the longitudinal through hole 105 in a conventional resonator, although still most concentrated in the longitudinal through hole, is moved slightly away from the tuning plug (downwardly in FIG. 4). Also, as previously noted in connection with FIG. 4A, the electric field is most strongly concentrated in the gap between the tuning plug 103 and the main body 101. Thus, the electric field is also moved away from the center of the resonator body as compared to a conventional resonator. However, it is shifted upwardly from the center in the opposite direction that the magnetic field is shifted. Thus, the electric and magnetic fields are physically displaced from each other in the resonator of the present invention as compared to a conventional resonator. Hence, movement of the tuning plug has an even smaller effect on the magnetic field (and therefore a commensurately smaller affect on the bandwidth of the filter).

As previously noted, the bandwidth of a dielectric resonator filter, is dictated primarily by coupling of the magnetic fields (not the electrical fields) of the resonators in the circuit. The more the magnetic coupling, the wider the bandwidth. The amount of magnetic coupling between resonators depends primarily on three factors. First, the more magnetic field outside of the resonator, the more coupling between adjacent resonators. Further, the closer the resonators are to each other, the more coupling. Finally, the cavity affects coupling strength. The same resonators placed in the same positions relative to each other will coupled with the different strengths in different sized cavities. Specifically, the presence of the resonators excites the cavity modes of the field configurations that coincide with those of the resonators and which respect the symmetry of the cavity. However, these are evanescent and not propagating modes supported by charges and currents on the inside surface of the cavity. There are many such modes, but generally only the fundamental mode contributes to and modifies the coupling between the resonators. The other modes have larger evanescent constants and, therefore, die out very fast. The interaction between the magnetic field of the resonators and the currents of the cavity affects the coupling and is responsible for most of the conductive losses.

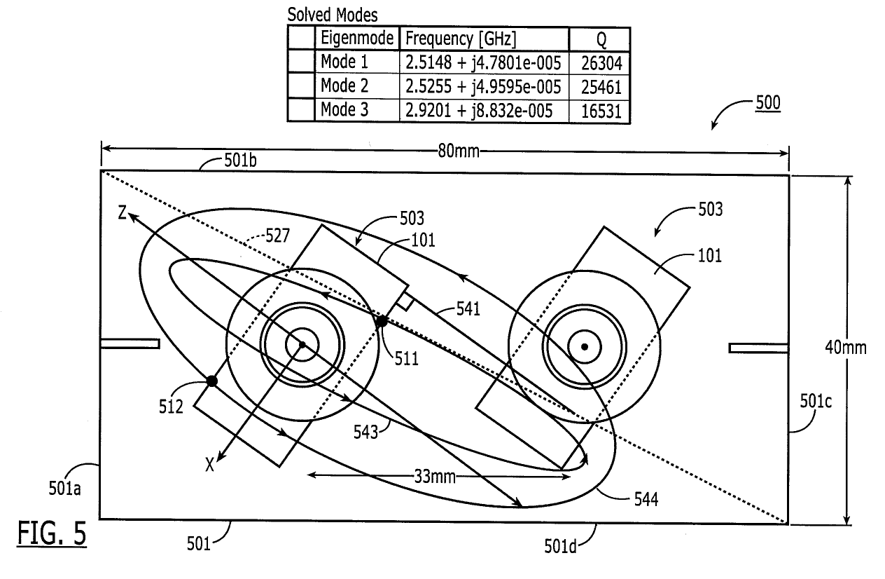

FIG. 5 is a diagram illustrating a two pole dielectric resonator filter 500 in accordance with the principles of the present invention employing techniques for adjusting coupling and, therefore, bandwidth over a broad range. In particular, the housing 501 is rectangular comprising four side walls 501a, 501b, 501c, 501d, a bottom wall 501e, and top wall (not shown). The housing is 80 mm×50 mm×40 mm. In this embodiment, there are no internal walls or irises between the resonators (so as to maximize coupling, and, therefore, bandwidth). The resonators 503-1 and 503-2 are spaced 33 mm from each other center-to-center. The resonators 503 are oriented within the housing 501 with their longitudinal axes (z) at an oblique angle to the side walls of the housing (an angle other than 0° or 90°). In FIG. 5, the resonators are oriented 350 to the long side walls 501b, 501d (or 650 to the short walls 501a, 501c). In the illustrated embodiment, the resonators are tilted relative to the side walls of the housing and not to the top and bottom walls. However, this is merely exemplary. What is significant is that the tilting increases the distance to the nearest wall of the housing along and immediately adjacent the central z axis of the resonator along which the magnetic field is most concentrated.

The resonators may be rotatably mounted to the housing by threaded screws extending in the y direction of the resonators that pass through matingly threaded holes in the housing.

As previously noted, the most concentrated portion of the magnetic field is displaced slightly downwardly from the central longitudinal axis (z) of the resonator (into the page in FIG. 5). However, this displacement is small and does not have a substantial bearing on the distance to the nearest wall in the z direction of the resonator. In fact, in the embodiment illustrated in FIG. 5, in which the tilting is solely about the y axis of the resonator, it has no bearing on the distance to the nearest metal along the z-axis of the resonator.

For a given resonator spacing, the coupling of the resonators depends substantially on the orientation of the resonators relative to the side walls, and particularly the long side walls 501b, 501d. Specifically, the losses depend mostly on the distance to the nearest wall to the resonator in the z-direction of the resonator because the greatest concentration of the magnetic field is in this direction towards that wall. By tilting the resonators, this distance is generally increased and, therefore, the Q of the resonator-cavity system is generally enhanced.

In the simple case of a rectangular enclosure such as illustrated in FIG. 5, the orientation relative to the long side walls 501b, 501d has a much greater effect on coupling between the resonators than do the short side walls 501a, 501c. Particularly, the enclosure itself has modes that are excited when the resonators are excited. The cavity modes, however, are evanescent modes that do not propagate, but stay in the vicinity of the enclosure and resonators. Nevertheless, the orientation of the resonators with respect to the magnetic fields of these evanescent cavity modes can affect the coupling between the resonators of the propagating resonator mode. The orientation of the magnetic field of the fundamental evanescent cavity mode most affects the coupling between the resonators. The field lines of this field are parallel to the long side walls 501b, 501d. Hence, the orientation of the resonators with respect to these field lines (which are parallel to the long side walls 501b, 501d) has a more significant impact on couplings of the fundamental mode of the resonators than do the short side walls 501a, 501c.

For other shapes of enclosures (e.g., folded, radial, etc.), the most significant walls with respect to the orientation of the resonators may be different than for the simple case of a rectangular enclosure.

Another significant feature is that the adjacent resonators that are to couple to each other are positioned so that they overlap each other in the z dimension of the resonators. That is, there is a portion of the main resonator body 101 of each resonator for which a line drawn parallel to the z axis of that resonator intersects the next, adjacent resonator with which it is to couple. For instance, see line 541 in FIG. 5. Overlapping helps assure that a relatively concentrated portion of the magnetic field lines of the resonator pass through the adjacent resonator.

Specifically, the magnetic field lines can be separated into two categories, namely direct coupling field lines and indirect coupling field lines. The direct coupling field lines are the field lines emanating from a first resonator that couple to the next (second) resonator in a “direct” path such as illustrated by field line 543 in FIG. 5 emanating from the right-hand resonator. These field lines enter the second resonator at a point 511 on the face of the resonator facing the first resonator (i.e., before the field line has curved significantly away from the z direction).

The indirect coupling field lines are the field lines that couple to the next resonator in an “indirect” path which have substantially turned in the opposite direction from which they originally emanated from the first resonator before entering the second resonator at a point 512 on the other side of the second resonator from the direct coupling field lines, such as illustrated by path 544 in FIG. 5.

The magnetic fluxes that indirectly couple to the second resonator are in anti-phase with the field lines that directly couple to the second resonator. The direct and indirect coupling field lines cancel each other partially.

As previously mentioned, the magnetic field flux from one resonator to the next defines the coupling strength. Two resonators are maximally coupled when the overlapping is maximum, i.e., when the z axes of the resonators are collinear and all coupling is direct coupling. Hence, there is only one corresponding flux.

On the other hand, when two resonators are completely non-overlapping (e.g., their z axes are normal to long side walls 501b, 501d), there is only indirect coupling. In this orientation, the coupling is still strong, but not as strong as in the case of complete overlap.

Orientations between these two extremes, such as oblique angle actually illustrated in FIG. 5, provide partial overlapping. At any orientation of the resonators between the two extremes of complete overlap (e.g., resonators parallel to the sides walls 501b and 501d) and no overlap (e.g., resonators normal to the sides walls 501b and 501d), both types of fluxes are competing with each other and the coupling can be adjusted anywhere between zero and maximum depending on the specific orientation of the resonators to each other.

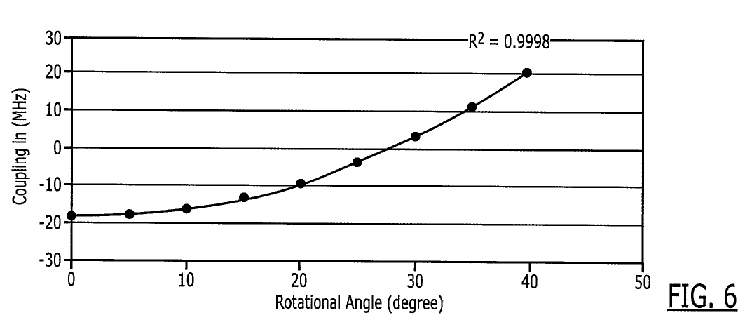

FIG. 6 is a graph illustrating coupling (in Megahertz) as a function of the angle of the resonators in the embodiment of FIG. 5. It can be seen that, in the range of about 30° to 40°, coupling strength can be adjusted from about 2 MHz to about 22 MHz. At the illustrated angle of 35° of FIG. 5, the distance on the z-axis of the resonators to the nearest metal is about 33 mm. This provides a coupling strength of about 11 MHz. As can be seen in FIG. 6, the zero total coupling corresponds to rotational angle near 27°.

In a preferred embodiment of the invention, a tuning screw 531 can be provided between the two resonators to fine tune the coupling strength (i.e., bandwidth).

A rectangular housing as illustrated by the embodiment of FIG. 5 is a relatively common shape for a housing of a dielectric resonator circuit. Furthermore, it is a particularly simple shape for illustrating the principles and advantages of the present invention. However, it should be understood that a rectangular housing is merely exemplary and that the tilting concept of the present invention can be practiced with housings of virtually any shape.

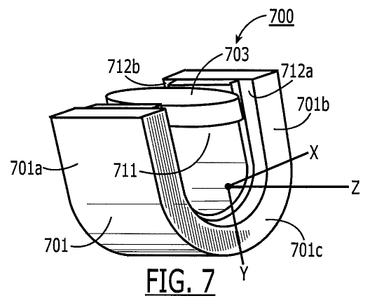

FIG. 7 is a perspective view of a dielectric resonator 700 according to another embodiment of the present invention. This resonator also has a main body portion 701 and a second, tuning plug portion 703. The main body portion 701 generally has the shape of a horseshoe or U comprising two parallel legs 701a, 701b joined at one end by a curved adjoining segment 701c. A tuning plug 703 is inserted between the two parallel legs 701a, 701b. The tuning plug 703 is shaped and dimensioned to substantially fill the space 711 between the two legs, but not physically contact the two legs. In a preferred embodiment, the open space between the two legs has counterbores 712a and 712b so that the space between the legs is greater at the ends of the space (in the z direction) than at the center of the space.

The principles of this embodiment are essentially similar to those of the first embodiment illustrated in FIG. 1. However, the horseshoe shape of the main body portion 701 is much easier to manufacture than the more annular main body portion 101 of the first embodiment shown in FIG. 1. Furthermore, while the tuning plug 703 may be cylindrical as illustrated, it also may be block shaped to correspond to the cross-section of the space 711 between the legs, also making the tuning plug easier to manufacture.

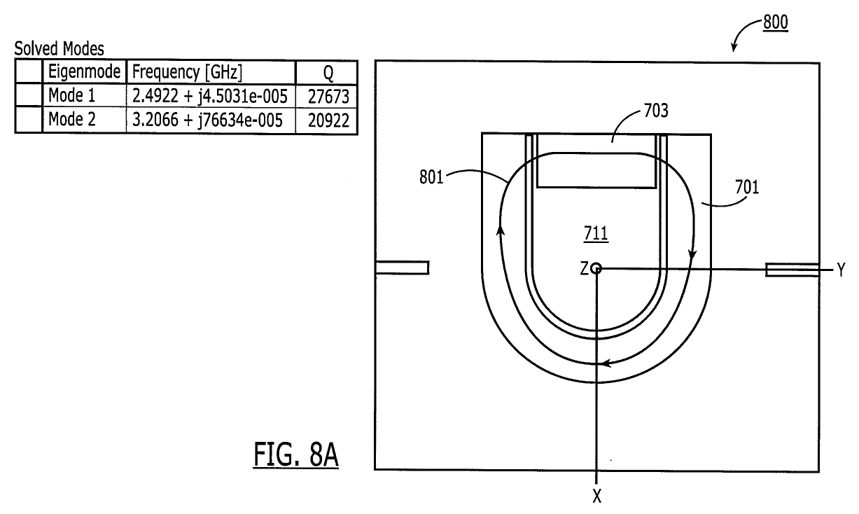

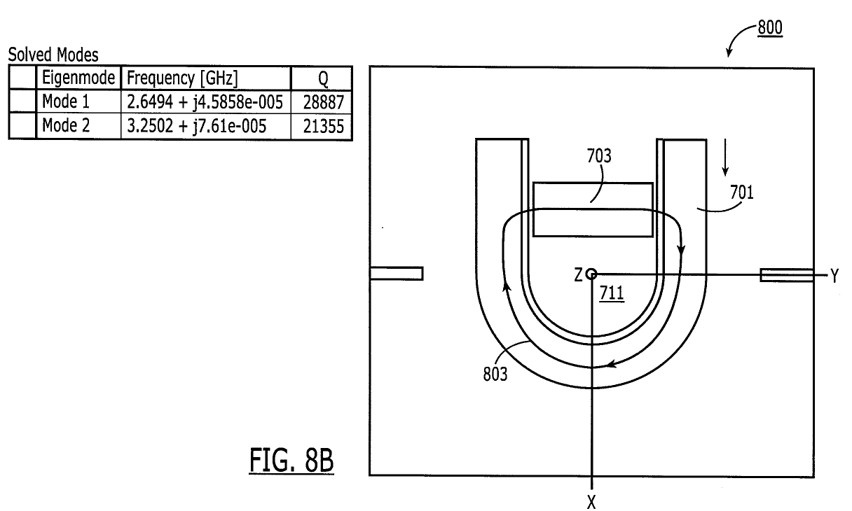

The TE field is in the x-y plane and is concentrated in the resonator material. The field lines are closed (and therefore generally circular) and are concentrated in the loosely circular path defined by tuning plug 703, leg 701a, adjoining portion 701c, and leg 701b. Hence, moving the tuning plug up and down along the y axis changes the size of the path of the TE field lines through the dielectric resonator material defined by the two legs 701a, 701b, adjoining portion 701c, and the tuning plug 703. Obviously, as the block is moved downwardly, the size of that space is decreased, thereby decreasing the space in which the TE field is concentrated. This increases the center frequency of the resonator. For instance, compare the field path 801 shown in FIG. 8A (801 being loosely representative of the concentrated portion of the TE field), to the field path 803 in FIG. 8B.

In one sense, the shape of the main body portion 701 in the embodiment of FIG. 7 is quite similar to that of the main body portion 101 in the embodiment of FIG. 1, but with the sides trimmed along two planes 734, 735 parallel to the x-y plane and the top cut off along plane 736. From the manufacturing standpoint, however, this resonator is much easier to machine on a machine tool at least because it does not include the two closed holes of the FIG. 1 embodiment. This embodiment has no closed holes.

FIG. 8A is a top plan view of an exemplary single pole dielectric filter circuit 800. The housing is 50 mm×46 mm×37 mm. The two legs of the resonator are each 15 mm long (in the vertical direction in the Figure) and 8 mm across (in the horizontal direction in the Figure). The adjoining segment of the resonator has an inner radius of 6 mm and an outer radius of 13 mm. Thus, the overall height of the resonator is 28 mm. The open space between the two legs is counterbored at both ends to a depth of 2 mm (in the z direction into and out of the page). The counterbored portions of the space between the legs is 8 mm across. The non-counterbored central portion of the space is 6 mm across. The thickness of the main body of the resonator (i.e., into and out of the page) is 12 mm. The tuning plug is cylindrical with a radius of 6.5 mm and a height of 6 mm. With the tuning plug 703 in the position shown in FIG. 8A (i.e., with the top surface of the tuning plug essentially even with the top surface of the legs), this filter has a center resonance frequency for the TE mode of 2.4922 GHz and a spurious response of 700 MHz. With the tuning plug moved down 8.5 mm almost to the bottom of the legs as illustrated in FIG. 8B, thus concentrating the TE field in a smaller space, the center frequency is moved up to 2.6494 GHz, a change of more than 150 MHz. The spurious, however, remains at approximately 700 MHz according to simulations.

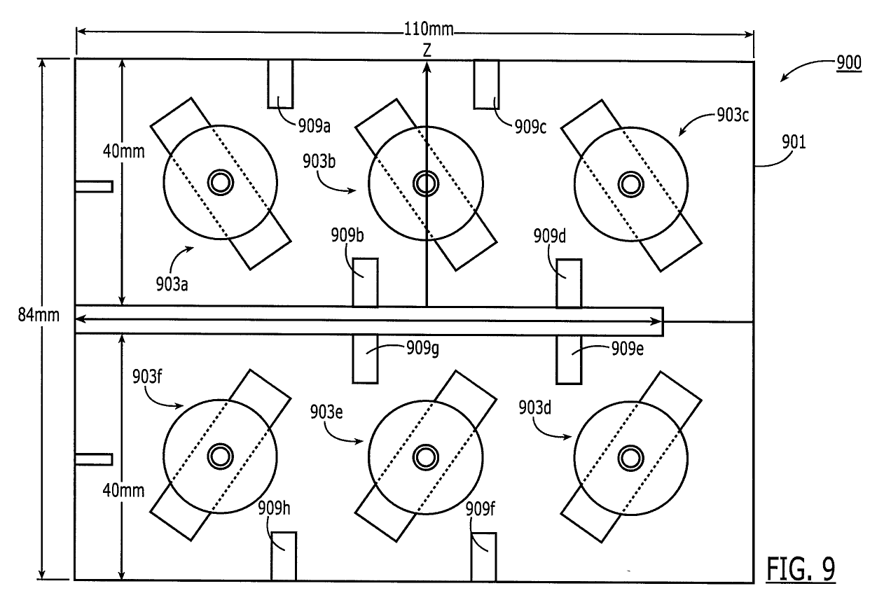

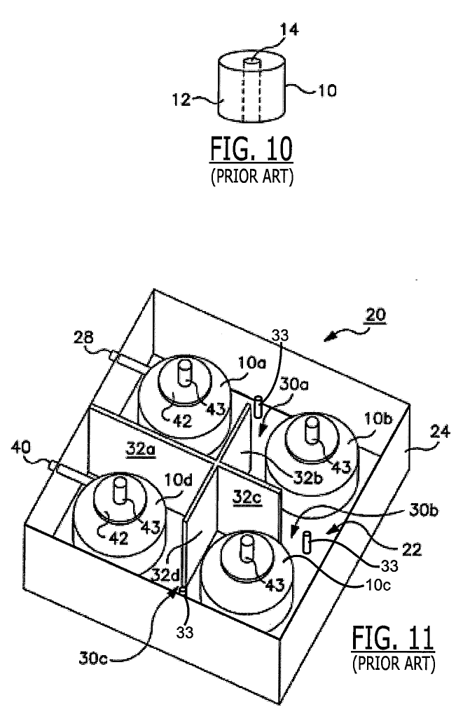

FIG. 9 is a side view of a six-pole dielectric resonator circuit 900 in accordance with the principles of the present invention. The dimensions of housing 901 are shown in FIG. 9. The resonators 903 are those of FIG. 7. The internal walls 909 are provided to help prevent cross coupling between nonadjacent resonators. For instance, internal walls 909a, 909b, 909c, and 909d help prevent cross coupling between dielectric resonators 903a and 903c without substantially affecting coupling between adjacent resonator pairs 909a and 909b.

Having thus described a few particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

We claim:

1. A dielectric resonator comprising:
a first body component comprising a substantial portion of a generally annular shape and having an open space substantially interrupting the annular shape; and
a second body portion shaped to substantially fill the open space without contacting the first body portion.

2. The dielectric resonator of claim 1 wherein the first body component comprises an annular shape defining an outer annular surface and an inner annular surface, the inner annular surface defining a first through hole in the first body component in a first direction, wherein the open space comprises a second through hole oriented in a second direction substantially perpendicular to the first through hole and extending between the outer annular surface and the inner annular surface, the second through hole comprising the open space.

3. The dielectric resonator of claim 2 wherein the second body portion comprises a first segment matingly shaped in cross section transverse the second direction to fit within the second through hole and positioned collinearly with the second through hole and a second segment larger than the first segment in cross section transverse the second direction.

4. The dielectric resonator of claim 2 wherein the second through hole is cylindrical and the first and second segments of the second body component are both cylindrical.

5. The dielectric resonator of claim 2 wherein the outer annular surface is substantially cylindrical except adjacent the second through hole, where said outer annular surface is planar in a direction perpendicular to the second direction.

6. The dielectric resonator of claim 5 wherein the first body component and the second body component are formed of the same dielectric material.

7. The dielectric resonator of claim 2 wherein the outer annular surface and the inner annular surface are joined by first and second side walls and wherein the side walls are beveled adjacent the outer annular wall.

8. The dielectric resonator of claim 2 wherein the first direction is substantially parallel to the TE mode field and the second direction is a direction that a magnetic field would take within the resonator.

9. The dielectric resonator of claim 1 wherein the first body component is U-shaped in a plane transverse a first direction, the shape defining a first leg and a second leg extending generally parallel to each other in a second direction and wherein the open space is between the first and second legs.

9. The dielectric resonator of claim 8 wherein the second body component is shorter than the open space in the second direction.

10. A dielectric resonator circuit comprising:
an enclosure;
an input coupler;
an output coupler; and
at least one dielectric resonator disposed in the enclosure, each resonator comprising;
a first body component comprising first and second substantially parallel faces, the first and second faces joined by at least one third face running between the first and second faces defining a periphery of the body, a first through opening in the body extending in a first direction perpendicular to the first and second faces, the first opening defining a fourth, inner face of the body, and a second opening in a second direction perpendicular to the first direction extending from the at least one third face to the fourth face; and
a second body component comprising a plug shaped and positioned to fit at least partially within the second opening, the second body component adjustably mounted to the enclosure so as to be movable relative to the first body component in the second direction to permit tuning of the circuit.

11. The circuit of claim 10 wherein the second body component is slightly smaller than the second opening and does not contact the first body portion.

12. The circuit of claim 11 wherein the at least one resonator comprises a plurality of resonators and wherein the resonators overlap each other in the first direction.

13. The circuit of claim 12 wherein the plurality of resonators are oriented with their first directions parallel to each other.

14. The circuit of claim 13 wherein the enclosure comprises a plurality of walls and wherein the dielectric resonators are oriented with their first directions oblique to at least some of the walls of the enclosure.

15. The circuit of claim 14 wherein the dielectric resonators are oriented with their first directions parallel to each other.

16. The circuit of claim 15 wherein the enclosure is rectangular.

17. The circuit of claim 10 wherein the plurality of resonators are adjustably mounted to the housing such that they are rotatable about an axis extending in the second direction.

18. The circuit of claim 17 further comprising:
a first plurality of threaded screws mounted through matingly threaded holes in the enclosure, each having a longitudinal axis oriented parallel to the second direction and wherein the plugs are attached to the screws, whereby rotation of the screws moves the plug relative to the first body components in the second direction;
a second plurality of threaded screws mounted through matingly threaded holes in the enclosure, each having a longitudinal axis oriented parallel to the second direction and wherein the first body components are attached to the screws, whereby rotation of the screws rotates the first body components about the longitudinal axis of the screws.

19. The circuit of claim 17 wherein the axes of rotation are located on the geometric centers of the resonators in the second direction.

20. A method of tuning a dielectric resonator circuit comprising a plurality of dielectric resonators disposed in a housing, each resonator comprising a first body component comprising first and second substantially parallel faces, the first and second faces joined by at least one third face running between the first and second faces defining a periphery of the body, a first through opening in the body extending in a first direction perpendicular to the first and second faces, the first opening defining a fourth, inner face of the body, and a second opening in a second direction perpendicular to the first direction extending from the at least one third face to the fourth face and a second body component comprising a plug matingly shaped to and collinear with the second opening, the second body component adjustably mounted to the enclosure so as to be movable relative to the first body component in the second direction to permit tuning of the circuit, the method comprising the steps of:
adjustably mounting the second body components to the housing so that the second body components are movable in the second hole in the second direction relative to the first body component of the resonator; and
moving the second body components in the second direction to alter the resonance frequencies of the resonators.

21. The method of claim 20 further comprising the steps of:
rotatably mounting the first body components to the housing so that the first body components are rotatable about axes extending in the second direction; and
rotating the first body components about the axes to adjust the bandwidth of the circuit.

22. The method of claim 21 wherein the circuit is a filter.

23. The method of claim 22 wherein the housing comprises a plurality of rectilinear walls and wherein the rotating step comprises adjusting the first body components such that their first directions are parallel to each other and oblique to the walls of the enclosure.
